(19) United States
(12) Patent Application Publication
(10) Pub. No.: US 2013/0070310 A1
(43) Pub. Date: Mar. 21, 2013

(54) OPTICAL SCANNING APPARATUS AND IMAGE FORMING APPARATUS

(71) Applicant: Takao Watanabe, Kanagawa (JP)

(72) Inventor: Takao Watanabe, Kanagawa (JP)

(21) Appl. No.: 13/602,476

(22) Filed: Sep. 4, 2012

(30) Foreign Application Priority Data
Sep. 16, 2011 (JP) 2011-203706

(51) Int. Cl. H04N 1/04

(52) U.S. Cl. 358/474

(57) ABSTRACT

An optical scanning apparatus includes a light source to emit a laser beam; an optical element disposed opposite the light source to split the laser beam into a plurality of laser beams, each of the split laser beams guidable to a corresponding scanning target selected from a plurality of scanning targets when forming a latent image thereon by controlling activation of the light source based on image data while shifting a scanning timing for each of the plurality of scanning targets when forming the latent image thereon; and a control unit, using a processing device, that switches the light source off for a specific scanning target on which an image is not to be written for a given image forming operation based on specific image data so that the specific scanning target is not scanned even when the specific scanning target enters its scanning timing.

### CROSS-REFERENCE TO RELATED APPLICATION

This application claims priority to Japanese Patent Application No. 2011-203706, filed on Sep. 16, 2011 in the Japan Patent Office, which is incorporated by reference herein in its entirety.

### BACKGROUND

1. Technical Field

The present invention relates to an optical scanning apparatus to scan a plurality of photoconductors using split laser beams, and an image forming apparatus employing the optical scanning apparatus.

2. Description of the Background Art

Typically, electrophotographic image forming apparatuses such as printers, copiers, and facsimile machines conduct an image forming process as follows. An optical scanning apparatus scans a surface of a photoconductor, charged to a given potential, using a laser beam to form an electrostatic latent image on the photoconductor. The formed electrostatic latent image is developed by toner, and the developed toner image is transferred on a sheet. The functions of electrophotographic image forming apparatuses have been enhanced, with the result that color image forming apparatuses and high-speed image forming apparatuses are now available. For example, tandem-type image forming apparatuses using a plurality of photoconductors such as four photoconductors are available.

Further, in addition to the tandem-type image forming apparatuses, color image forming apparatuses can be configured with only one photoconductor. In this case, if four colors are used for an image forming operation, the exposure of the photoconductor, the image development, and the image transfer to an intermediate transfer belt needs to be repeated four times while the color alignment of each of colors is conducted. Therefore, productivity suffers compared to the tandem-type image forming apparatus.

Because a plurality of photoconductors are scanned for the tandem-type image forming apparatus, the number of light sources is increased, the number of parts is also increased, and color light deviation between the light sources due to wavelength difference occurs, leading to a cost increase as well. Further, if the number of light sources is increased, the probability of a malfunction of the semiconductor lasers that are used as the light source increases, limiting the ability to recycle the light source.

To reduce the number of light sources, a beam split structure can be used, in which a laser beam emitted from one light source is split and the split laser beams are guided to different photoconductors. For example, JP-2002-23085-A discloses an optical scanning apparatus having a common deflector for two photoconductors disposed parallel to the common deflector, in which the deflector element may be a pyramidal mirror or a flat mirror, and the two photoconductors are scanned by a laser beam emitted from a common light source.

Further, JP-2005-92129-A discloses an optical scanning apparatus in which a half-mirror prism is used as an optical element to split a laser beam emitted from a common light source into two laser beams. One of the two laser beams is directed onto an upper polygon mirror and the other laser beam strikes a lower polygon mirror, with phases of the upper and lower polygon mirrors shifted, so that the two photoconductors are optically scanned by the deflected laser beams with a time lag.

In yet another configuration, a liquid crystal shutter is used as a deflector element and the direction of the laser beam is selectively set for the scan timing of corresponding photoconductors.

However, there are problems with each of the approaches described above. The number of light sources of the optical scanning apparatus can be reduced for the device disclosed in JP-2002-23085-A, but because a laser beam emitted from the common light source is used to scan two photoconductors at once when the deflector element rotates once, there is a limit to how much the scanning speed can be increased.

As for the method using the liquid crystal shutter, there is a limit to control of the liquid crystal shutter, and to deflection responsiveness and deflection angles.

The device disclosed in JP-2005-92129-A uses a polygon mirror having two stages, and each stage has at least four deflection/reflection faces, by which four scanning operations can be conducted per rotation for increased scanning speed. Further, JP-2005-92129-A does not use a liquid crystal shutter, allowing the optical scanning apparatus to be configured simply.

However, image formation involving fewer than all four of the photoconductors can cause problems. For example, when a black-and-white monochrome image is print, a laser beam scans one or more photoconductors not used for such printing, thereby subjected the photoconductor(s) not used for printing to unnecessary exposure, which shortens their lifespan.

### SUMMARY

In one aspect of the present invention, an optical scanning apparatus is devised. The optical scanning apparatus includes a light source to emit a laser beam; an optical element disposed opposite the light source to split the laser beam into a plurality of laser beams, each of the split laser beams guidable to a corresponding scanning target selected from a plurality of scanning targets when forming a latent image thereon by controlling activation of the light source based on image data while shifting a scanning timing for each of the plurality of scanning targets when forming the latent image thereon; and a control unit, using a processing device, that switches the light source off for a specific scanning target on which an image is not to be written for a given image forming operation based on specific image data so that the specific scanning target is not scanned even when the specific scanning target enters its scanning timing.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 shows a schematic cross-sectional view of an image forming apparatus according to an example embodiment;

FIG. 2 shows a detailed structure of an optical scanning apparatus included in the image forming apparatus of FIG. 1;

FIG. 3 shows a cross-sectional view of a half-mirror prism of FIG. 2, which is a cut-view in the sub-scanning direction;

FIGS. 4(a) and 4(b) show plan views of a polygon mirror of FIG. 2 and laser beams deflected by the polygon mirror;

FIG. 5 shows a block diagram of a hardware configuration of a control system of the image forming apparatus of FIG. 1;

FIG. 6 shows a functional block diagram of a control unit of FIG. 5;

FIG. 7 shows a time chart when forming electrostatic latent images of black and cyan in a full-color printing mode;

FIG. 8 shows a time chart when forming an electrostatic latent image of black in a black-and-white monochrome image printing mode; and

FIG. 9 shows another time chart when forming an electrostatic latent image of black in the black-and-white monochrome image printing mode, which is compared with a case shown in FIG. 8.

### DETAILED DESCRIPTION OF EXEMPLARY EMBODIMENTS

A description is now given of exemplary embodiments of the present invention. It should be noted that although such terms as first, second, etc. may be used herein to describe various elements, components, regions, layers and/or sections, it should be understood that such elements, components, regions, layers and/or sections are not limited thereby because such terms are relative, that is, used only to distinguish one element, component, region, layer or section from another region, layer or section. Thus, for example, a first element, component, region, layer or section discussed below could be termed a second element, component, region, layer or section without departing from the teachings of the present invention.

In addition, it should be noted that the terminology used herein is for the purpose of describing particular embodiments only and is not intended to be limiting of the present invention. Thus, for example, as used herein, the singular forms “a”, “an” and “the” are intended to include the plural forms as well, unless the context clearly indicates otherwise. Moreover, the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Furthermore, although in describing views shown in the drawings, specific terminology is employed for the sake of clarity, the present disclosure is not limited to the specific terminology so selected and it is to be understood that each specific element includes all technical equivalents that operate in a similar manner and achieve a similar result. Referring now to the drawings, an apparatus or system according to an example embodiment is described hereinafter.

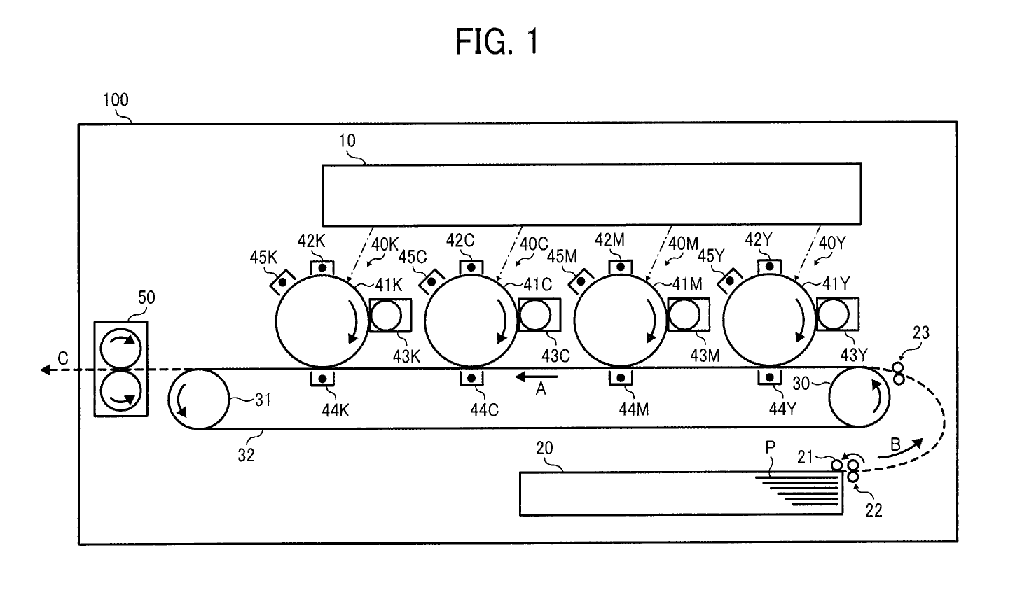

FIG. 1 shows a schematic cross-sectional view of an image forming apparatus 100 according to an example embodiment. The image forming apparatus 100 may be a tandem-type image forming apparatus. The image forming apparatus 100 may include an optical scanning apparatus 10, a sheet-feed tray 20, a sheet-feed roller 21, separation rollers 22, registration rollers 23, a drive roller 30, a driven roller 31, a transport belt 32, image forming units 40Y, 40M, 40C, and 40K, and a fusing unit 50.

Further, the image forming units 40Y, 40M, 40C, and 40K includes photoconductors 41Y, 41M, 41C, and 41K, chargers 42Y, 42M, 42C, and 42K, developing units 43Y, 43M, 43C, and 43K, transfer units 44Y, 44M, 44C, and 44K, and cleaners 45Y, 45M, 45C, and 45K. The suffix letters of Y, M, C, and K respectively corresponds to yellow (Y), magenta (M), cyan (C), and black (K). Such suffix letters may be omitted if the color difference does not affect functionality. Further, a sheet transport route to pass through sheets is indicated by a dotted line in FIG. 1, and the light path is indicated by a dashed line in FIG. 1.

The optical scanning apparatus 10 exposes the charged surfaces of the photoconductors 41Y, 41M, 41C, and 41 by irradiating laser beams based on image data to form electrostatic latent images on the charged surfaces of the photoconductors 41Y, 41M, 41C, and 41. The optical scanning apparatus 10 employs a light flux splitting system, in which a laser beam emitted from a light source is split into a two light flux such as laser beams, and such split laser beam is used to scan the photoconductor 41. The optical scanning apparatus 10 will be explained later.

The sheet-feed tray 20 stacks and stores recording sheet P. In FIG. 1, the sheet-feed tray 20 is one stage, but a multiple stages such as upper to lower stages. The sheet-feed roller 21 is rotated into the counter-clockwise direction a sheet feed motor to eject the top sheet of the recording sheet P stacked in the sheet-feed tray 20.

As similar to the sheet-feed roller 21, the separation rollers 22 can be rotated in the counter-clockwise direction to guide the recording sheet P one by one to a transport route (see the dotted line in FIG. 1). The registration rollers 23 are used as a position determination roller to stop the recording sheet P transported in the transport route to conduct the skew correction. After the skew correction, the registration rollers 23 feed the recording sheet P at a timing that a toner image comes to the transfer nip set between the photoconductor 40 and the transfer unit 44. The drive roller 30, driven by a drive motor in a direction shown by an arrow, can rotate the transport belt 32 in a direction shown by an arrow A in FIG. 1, in which the driven roller 31 can be rotated in a direction shown by an arrow.

The transport belt 32 is an endless belt, extended by the drive roller 30 and the driven roller 31, and can be rotated in the direction shown by the arrow A. The transport belt 32 transports the recording sheet P, sequentially transferred with toner images, to the fusing unit 50.

The image forming unit 40 may include the photoconductor 41, the charger 42, the developing unit 43, the transfer unit 44, and the cleaner 45. The photoconductor 41, the charger 42, the developing unit 43, the transfer unit 44, and the cleaner 45 can be integrated as one unit. The photoconductor 41 can be referred to a scanning target. The charger 42 charges the surface of the photoconductor 41 at a given potential. The developing unit 43 develops an electrostatic latent image formed by the optical scanning apparatus 10 as a toner image. The transfer unit 44 applies a transfer bias, having a polarity opposite to the polarity of the toner image carried on the photoconductor 41, from the rear face of the recording sheet P to transfer the toner image from the photoconductor 41 to the recording sheet P. The cleaner 45 removes toner remaining on the photoconductor 41 after the toner image transfer.

The image forming apparatus 100 may use four image forming units 40 such as the image forming units 40Y, 40M, 40C, and 40K disposed along the transport direction of the transport belt 32 for each one of colors. Such image forming apparatus 100 can function as a tandem-type image forming apparatus, in which the toner images of each color can be sequentially transferred on the recording sheet P transported by the transport belt 32, by which a color image can be formed by synthesizing the toner images. The fusing unit 50 includes a heat roller and a pressure roller. The fusing unit 50 applies heat and pressure to the recording sheet P transported from the transport belt 32 to fuse the toner images on the recording sheet P.

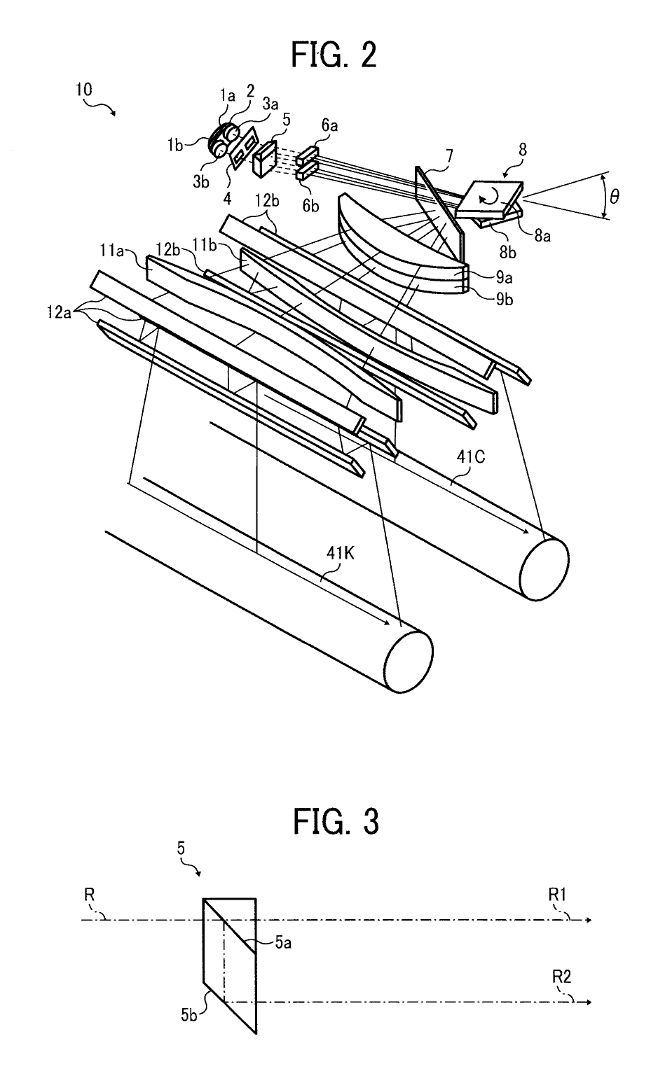

A description is given of the optical scanning apparatus 10 employed for the image forming apparatus 100 with reference to FIG. 2, which shows a detailed structure of the optical scanning apparatus 10. The optical scanning apparatus 10 employs a light flux splitting system, in which split laser beams can be used to scan the photoconductors 41K and 41C. The optical scanning apparatus 10 may include laser diodes (LDs) 1a, 1b, a holder 2, collimator lenses 3a, 3b, an aperture member 4, a half-mirror prism 5, cylindrical lenses 6a, 6b, a sound proof glass 7, a polygon mirror 8, first scan lenses 9a, 9b, second scan lenses 11a, 11b, and light path reflection mirrors 12a, 12b.

Such configuration of the optical scanning apparatus 10 can be used for scanning the photoconductors 41K and 41C. Further, the optical scanning apparatus 10 includes another similar configuration excluding the polygon mirror 8, in which laser diodes (LDs) different from the LDs 1a, 1b emit laser beams, and such laser beams are deflected by the polygon mirror 8 to scan the photoconductors 41Y and 41M. For the simplicity of the explanation, only the configuration for scanning the photoconductors 41K and 41C is shown in FIG. 2. Further, a synchronization detection sensor is disposed for each one of the photoconductors 41Y, 41M, 41C, and 41K to determine a scan timing to scan the photoconductors 41Y, 41M, 41C, and 41K. The synchronization detection sensor is disposed at a position of non-scanning areas of the photoconductors 41Y, 41M, 41C, and 41K, not used for the scanning process.

Each of the LDs 1a and 1b is an example of a light source, which may be a semiconductor laser to emit a laser beam having a specific wavelength. The holder 2 is used to maintain a given positional relationship between the LDs 1a and 1b. The collimator lenses 3a, 3b respectively collimate the laser beams emitted from the LDs 1a and 1b as parallel light flux. The aperture member 4 includes two openings. By passing the laser beams emitted from the LDs 1a and 1b through the respective openings of the aperture member 4, the beam width is controlled, by which a shape of laser beam can be set. The half-mirror prism 5 is an example of optical element to split the laser beam emitted from each one of the LDs 1a and 1b into the upper and lower direction in the sub-scanning direction.

The half-mirror prism 5 is explained with reference to FIG. 3. FIG. 3 shows a cross-sectional view of the half-mirror prism 5 in the sub-scanning direction. For the simplicity of the explanation, the laser beam R emitted from the LD 1a is used (see the dashed line in FIG. 3).

The half-mirror prism 5 includes a semi-transmittance face 5a and a reflection face 5b. The semi-transmittance face 5a splits the laser beam R into a passing light and a reflection light with a ratio of, for example, 1:1. The reflection face 5b totally reflects the reflection light. Specifically, a laser beam R emitted from the LD 1a can be split into a laser beam R1 and a laser beam R2 by the half-mirror prism 5. The laser beam R1 passes through the semi-transmittance face 5a of the half-mirror prism 5 straight forwardly.

In contrast, the laser beam R2 is reflected at the semi-transmittance face 5a. Further, the laser beam R2 is totally reflected at the reflection face 5b with a right angle, and is output in parallel to the laser beam R1.

Further, the laser beam of the LD 1b also enters the half-mirror prism 5 as similar to the laser beam R, and then split into two light beams in the sub-scanning direction. As such, the laser beam of the LD 1a is split into two light beams at the half-mirror prism 5, and the laser beam of the LD 1b is split into two light beams at the half-mirror prism 5. Therefore, four laser beams can be output from the half-mirror prism 5. It should be noted that the laser beam splitting is not required to use the half-mirror prism 5, but other methods can be used. Further, the laser beam is not required to split into two beams with a ratio of 1:1, but other ratio can be used.

The laser beam R emitted from the LD 1a is processed by the cylindrical lenses 6a and 6b as follows. For example, the cylindrical lens 6a focuses the laser beam R1 that passes through the half-mirror prism 5 straight forwardly in the sub-scanning direction, and guides the laser beam R1 to an upper polygon mirror 8a of the polygon mirror 8 having the upper and lower stages of mirror. Further, the cylindrical lens 6b focuses the laser beam R2, reflected at the reflection face 5b of the half-mirror prism 5 in the sub-scanning direction, and guides the laser beam R2 to a lower polygon mirror 8b of the polygon mirror 8.

Further, the laser beam emitted from the LD 1b can be processed with a similar manner. For example, the laser beam that passes through the half-mirror prism 5 straight forwardly is guided to the upper polygon mirror 8a by the cylindrical lens 6a, and the laser beam reflected at the reflection face 5b of the half-mirror prism 5 is guided to the lower polygon mirror 8b by the cylindrical lens 6b.

The sound proof glass 7 is disposed near the polygon mirror 8 to mitigate the vibration sound caused by the rotation of the polygon mirror 8. Further, the sound proof glass 7 can pass through the laser beams to the polygon mirror 8, and such laser beams are deflected by the polygon mirror 8. The polygon mirror 8 is an example of a deflector, which can be rotated in a direction shown by an arrow in FIG. 2 by a polygon motor 240 (FIG. 5) to be described later. For example, the polygon mirror 8 includes the upper polygon mirror 8a and the lower polygon mirror 8b as the two-stage polygon mirror, and each of the upper polygon mirror 8a and the lower polygon mirror 8b has four deflection/reflection faces.

Among the laser beams emitted from the LDs 1a and 1b, the two laser beams that pass through the half-mirror prism 5 straight forwardly enter the upper polygon mirror 8a, and are deflected to a scanning direction (e.g., main scanning direction) to scan the photoconductor 41K. Meanwhile, the two laser beams reflected at the reflection face 5b of the half-mirror prism 5 enter the lower polygon mirror 8b, and are deflected to a scanning direction (e.g., main scanning direction) to scan the photoconductor 41C. The deflection configuration of the polygon mirror 8 will be described later. The first scan lens 9a, the second scan lens 11a, and the light path reflection mirror 12a guide the two laser beams deflected by the upper polygon mirror 8a to the photoconductor 41K, which is a scanning target object, and the two laser beams form two light-beam spots separated in the sub-scanning direction.

Further, the first scan lens 9b, the second scan lens 11b and the light path reflection mirror 12b guide the two laser beams deflected by the lower polygon mirror 8b to the photoconductor 41C which is a scanning target object, and the two laser beams form two light-beam spots separated in the sub-scanning direction.

With such a configuration, an electrostatic latent image can be formed on the photoconductor 41K by scanning the photoconductor 41K by using the two laser beams deflected by the upper polygon mirror 8a as multiple-beams to scan the photoconductor 41K, which is a multiple-beam scanning process such as two-line scanning process. Further, an electrostatic latent image can be formed on the photoconductor 41C by scanning the photoconductor 41C by using the two laser beams deflected by the upper polygon mirror 8b as multiple-beam to scan the photoconductor 41C, which is a multiple-beam scanning process such as two-line scanning process.

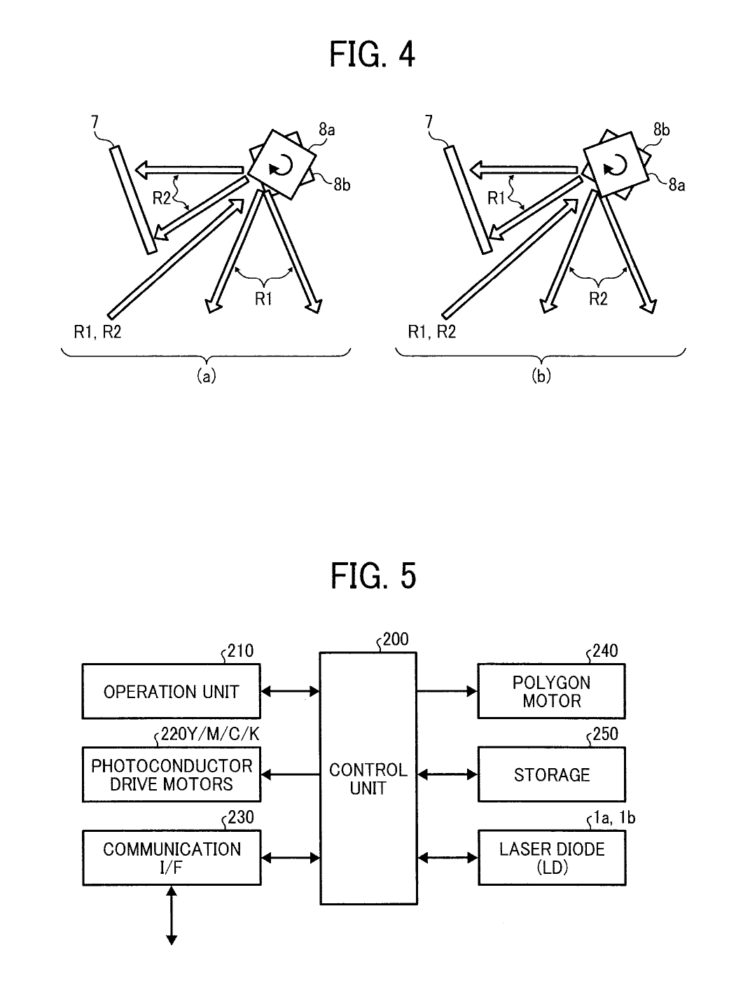

A description is given of deflection by the polygon mirror 8 with reference to FIG. 4. FIG. 4 shows a plan view of the polygon mirror 8 of FIG. 2, in which deflection patterns of laser beams are shown. FIG. 4(a) shows a deflection pattern of the laser beam that enters the upper polygon mirror 8a, in which the laser beam is deflected to a scanning direction (e.g., main scanning direction) of the photoconductor 41K. FIG. 4(b) shows a deflection pattern of the laser beam that enters the lower polygon mirror 8b, in which the laser beam is deflected to a scanning direction (e.g., main scanning direction) of the photoconductor 41C.

Further, in FIG. 4, for the simplicity of the explanation, the laser beams R1 and R2, which are split by the half-mirror prism 5, are shown. As shown in FIG. 4, the upper polygon mirror 8a and the lower polygon mirror 8b can be integrally rotated while setting a given phase shift therebetween such as a phase shift of 45°, by which the scan timing of the photoconductors 41K and 41C can be set differently.

As shown in FIG. 4(a), while the laser beam R1 deflected by the upper polygon mirror 8a is scanning the photoconductor 41K, the laser beam R2 deflected by the lower polygon mirror 8b is blocked at an inner face of the sound proof glass 7. In contrast, as shown in FIG. 4(b), while the laser beam R2 deflected by the lower polygon mirror 8b is scanning the photoconductor 41C, the laser beam R1 deflected by the upper polygon mirror 8a is blocked at the inner face of the sound proof glass 7.

As such, when the photoconductor 41K is scanned by the laser beam R1, the photoconductor 41C is not scanned, and when the photoconductor 41C is scanned by the laser beam R2, the photoconductor 41K is not scanned. Therefore, the scanning of the photoconductor 41K and the scanning of the photoconductor 41C can be conducted by shifting the scanning period or timing, which means that the scanning of the photoconductor 41K and the photoconductor 41C can be conducted interchangeably without overlapping the scanning time of photoconductors 41K and 41C.

Further, as similar to FIG. 4(a) and FIG. 4(b), a laser beam emitted from another LD is split into two laser beams by the half-mirror prism 5, and deflected by the polygon mirror 8, and each of the two laser beams is used to scan the corresponding photoconductors 41Y or 41M by shifting the scanning period or timing, which means that the scanning of the photoconductor 41Y and the photoconductor 41M can be conducted interchangeably without overlapping the scanning time of photoconductors 41Y and 41M.

Further, the inner face of the sound proof glass 7 may be, for example, formed as a non-reflection face. In a situation of FIG. 4(a), while the laser beam R1 scans the photoconductor 41K, the laser beam R2 may scan the photoconductor 41K as a ghost light. By setting the inner face of the sound proof glass 7 as the non-reflection face, the laser beam R2 can be blocked completely.

In the above described optical scanning apparatus 10, the laser beams emitted from the LD 1a and 1b are split by the half-mirror prism 5 into four laser beams in total.

Two laser beams passing through the half-mirror prism 5 straight forwardly are deflected by the upper polygon mirror 8a, and then guided to the photoconductor 41K via the first scan lens 9a, the second scan lens 11a, and the light path reflection mirror 12a, by which a multi-beam scanning using two light-beam spots separated in the sub-scanning direction can be conducted.

Further, another two laser beams reflected at the reflection face 5b of the half-mirror prism 5 are deflected by the lower polygon mirror 8b, and then guided to the photoconductor 41C via the first scan lens 9b, the second scan lens 11b, and the light path reflection mirror 12b, by which a multi-beam scanning using two light-beam spots separated in the sub-scanning direction can be conducted.

Further, the scan-start timing to start a scanning operation of each of the photoconductors 41K and 41C can be determined using the synchronization detection sensor disposed at a non-scanning area set for each one of the photoconductors 41K and 41C. Specifically, the laser beams deflected by the upper polygon mirror 8a and the laser beams deflected by the lower polygon mirror 8b can be detected by the corresponding synchronization detection sensor to set the scan-start timing.

As such, in the optical scanning apparatus 10, the laser beam is split by a light flux splitting system, and each of the split laser beams is guided to a corresponding photoconductor at different timing. Therefore, the scanning of each of the photoconductors can be conducted by shifting the scanning period or timing, which means that the scanning of each of the photoconductors can be conducted interchangeably without overlapping the scanning time of the photoconductors, and the scanning can be conducted using a multi-beam scanning.

A description is given of a hardware configuration of a control system of the image forming apparatus 100 of FIG. 1 with reference to FIG. 5. As shown in FIG. 5, the image forming apparatus 100 may include a control unit 200, an operation unit 210, photoconductor drive motors 220Y, 220M, 220C, 220K, a communication interface (I/F) 230, a polygon motor 240, a storage 250, and the laser diodes (LDs) 1a, 1b. The explanation is omitted for the LDs 1a and 1b because the LDs 1a and 1b are explained with FIG. 2.

The control unit 200 may be a processor or circuit having one or more central processing units (CPUs). The control unit 200 executes various processing such as sheet feeding, sheet transportation, image transfer, image fusing, and sheet ejection by controlling various devices or the like, and motors included in the image forming apparatus 100. Further, the control unit 200 controls the optical scanning apparatus 10 included in the image forming apparatus 100, and has various functions to control the optical scanning apparatus 10. The functions of the control unit 200 will be explained later. Further, the control unit 200 may include a read only memory (ROM) and a random access memory (RAM). The ROM stores programs to execute the above described processing. The RAM can be loaded with such programs, and can be used as a working area to execute such programs. Further, the control unit 200 controls motors such as a sheet feed motor to rotate the sheet-feed roller 21, a registration motor to rotate the registration rollers 23, and a transport motor to rotate the transport belt 32 (see FIG. 1), as required.

The operation unit 210 may include a display unit such as a liquid crystal display and a touch panel, and buttons. The operation unit 210 can be used to notify the status of the image forming apparatus 100 to a user through a screen display, and can be used to input print mode instructions by users such as the full-color printing mode, non-full-color printing mode, and black-and-white monochrome image printing mode.

The photoconductor drive motors 220Y, 220M, 220C, and 220K are drive sources such as motors to rotate the photoconductors 41Y, 41M, 41C, and 41K respectively.

The communication I/F 230 is an interface between the image forming apparatus 100 and other apparatuses such as a personal computer. The communication I/F 230 can connect the image forming apparatus 100 and other apparatuses via networks and/or universal serial bus (USB) cables to conduct communication, and transmission/reception of image data. Further, the communication I/F 230 may be selected in view of network standards and communication protocols. Further, the communication I/F 230 may include a plurality of I/Fs corresponding to a plurality of standards.

The polygon motor 240 is a motor to rotate the polygon mirror 8 included in the optical scanning apparatus 10 (see FIG. 2). The storage 250 may be a non-volatile memory to store control parameters required for printing such as transfer bias of the transfer units 44Y, 44M, 44C, and 44K, and fusing temperature of the fusing unit 50.

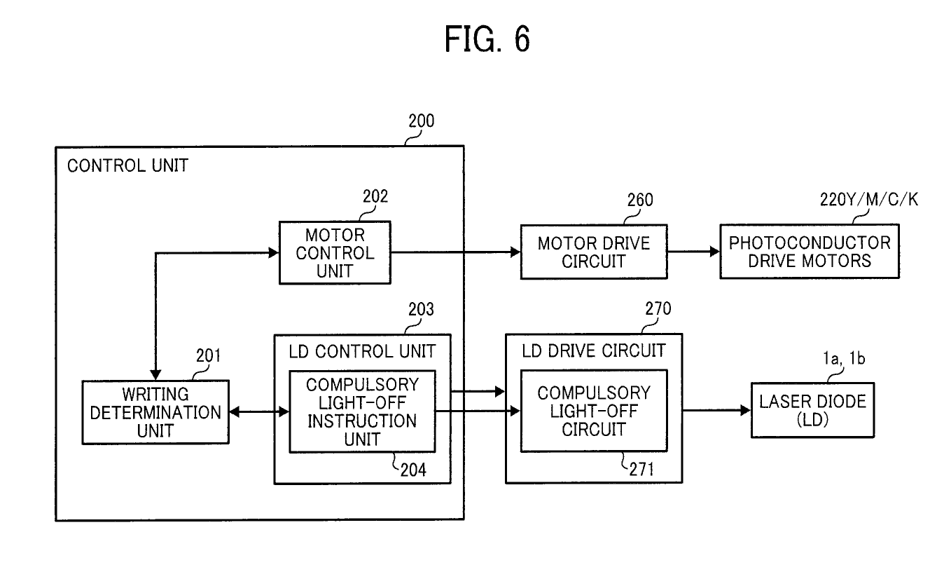

A description is given of controlling of the optical scanning apparatus 10 by the control unit 200 with reference to FIG. 6, which shows a functional block diagram of the control unit 200 of FIG. 5. FIG. 6 mainly shows functions related to features according to an example embodiment, but the control unit 200 may have other functions such as a function to control the polygon motor 240 and other motors. As shown in FIG. 6, the control unit 200 includes, for example, a writing determination unit 201, a motor control unit 202, and a LD control unit 203.

Based on information of printing mode included in image data or job data of to-be-executed job, the writing determination unit 201 determines whether an electrostatic latent image is required to be written on the photoconductors 41Y, 41M, 41C, and 41K. For example, when the writing determination unit 201 receives an instruction of the full-color printing mode from a printer driver of a personal computer operated by a user via the communication I/F 230, the writing determination unit 201 recognizes the image data received with such instruction as a full color image, and determines that all of the photoconductors 41Y, 41M, 41C, and 41K are required to be written with an electrostatic latent image, which means each of the photoconductors 41Y, 41M, 41C, and 41K are determined as an activation-required photoconductor. Further, when a user operates a scanner and instructs the full-color printing mode via the operation unit 210, the writing determination unit 201 recognizes whether the scanned image data is a color image.

Based on the determination result of the writing determination unit 201, the motor control unit 202 transmits an instruction to a motor drive circuit 260. Specifically, the motor control unit 202 instructs the motor drive circuit 260 whether to drive each one of the photoconductor drive motors 220Y, 220M, 220C, and 220K. For example, if the writing determination unit 201 determines that all of the photoconductors 41Y, 41M, 41C, and 41K are required to be written with electrostatic latent images, the motor control unit 202 instructs the motor drive circuit 260 to drive all of the photoconductor drive motors 220Y, 220M, 220C, and 220K. As such, based on the instruction of the motor control unit 202, the motor drive circuit 260 can selectively drive the photoconductor drive motors 220Y, 220M, 220C, and 220K to rotate the photoconductors 41Y, 41M, 41C, and 41K.

The LD control unit 203 instructs a LD drive circuit 270 to execute a writing of electrostatic latent images onto the photoconductors 41Y, 41M, 41C, and 41K. The LD control unit 203 includes a compulsory light-OFF instruction unit 204, and the LD drive circuit 270 includes a compulsory light-OFF circuit 271. Based on the determination result of the writing determination unit 201, the compulsory light-OFF instruction unit 204 instructs the compulsory light-OFF circuit 271 to set the compulsory light-OFF condition for any one of the LDs 1a and 1b so that a photoconductor, not required to be written with an electrostatic latent image, is not written with the electrostatic latent image.

For example, when the LD control unit 203 instructs the LD drive circuit 270 to write an electrostatic latent image on all of the photoconductors 41Y, 41M, 41C, and 41K, and the writing determination unit 201 determines that all of the photoconductors 41Y, 41M, 41C, and 41K are required to be written with the electrostatic latent image, the compulsory light-OFF instruction unit 204 does not instruct the compulsory light-OFF circuit 271.

In contrast, when the writing determination unit 201 determines that the photoconductor 41C, which is one of the photoconductors 41Y, 41M, 41C, and 41K, is not required to be written with the electrostatic latent image, the compulsory light-OFF instruction unit 204 instructs the compulsory light-OFF circuit 271 to set the compulsory light-OFF condition for the LDs 1a and 1b so that a writing operation is not conducted for the photoconductor 41C. Such instruction can be instructed by transmitting a signal indicating no writing operation is to be conducted for a specific photoconductor.

Based on the instruction from the LD control unit 203, and the scan timing detected by the synchronization detection sensor disposed for each of the photoconductors 41Y, 41M, 41C, and 41K, the LD drive circuit 270 controls the activation of LDs such as the LDs 1a and 1b for scanning the photoconductors 41K and 41C, and other LDs for scanning the photoconductors 41Y and 41M, which are different from the LDs 1a and 1b.

Further, based on the instruction from the compulsory light-OFF instruction unit 204, the compulsory light-OFF circuit 271 of the LD drive circuit 270 determines a scan timing to scan an activation-not-required photoconductor, which is not required to be written with a latent image, by using the synchronization detection sensor. It should be noted that although the activation-not-required photoconductor is not used for an image forming operation, the laser beam strikes the activation-not-required photoconductor when the activation-not-required photoconductor comes to a position corresponding to the scan timing of the activation-not-required photoconductor. Therefore, during the determined scan timing of the activation-not-required photoconductor, the compulsory light-OFF circuit 271 of the LD drive circuit 270 compulsory controls LDs such as the LDs 1a and 1b and other LDs at the light-OFF during the scan timing of such photoconductor.

For example, when the compulsory light-OFF circuit 271 receives an instruction from the compulsory light-OFF instruction unit 204 not to conduct a writing operation to the photoconductor 41C by setting the compulsory light-OFF for the LDs 1a and 1b, the compulsory light-OFF circuit 271 controls the LDs 1a and 1b at the light-OFF condition during the scan timing of the photoconductor 41C so that the photoconductor 41C, which is in the scan timing, is not irradiated by the laser beams coming from the LDs 1a and 1b. As such, the compulsory light-OFF instruction unit 204 and the compulsory light-OFF circuit 271 can be used as a kind of control unit.

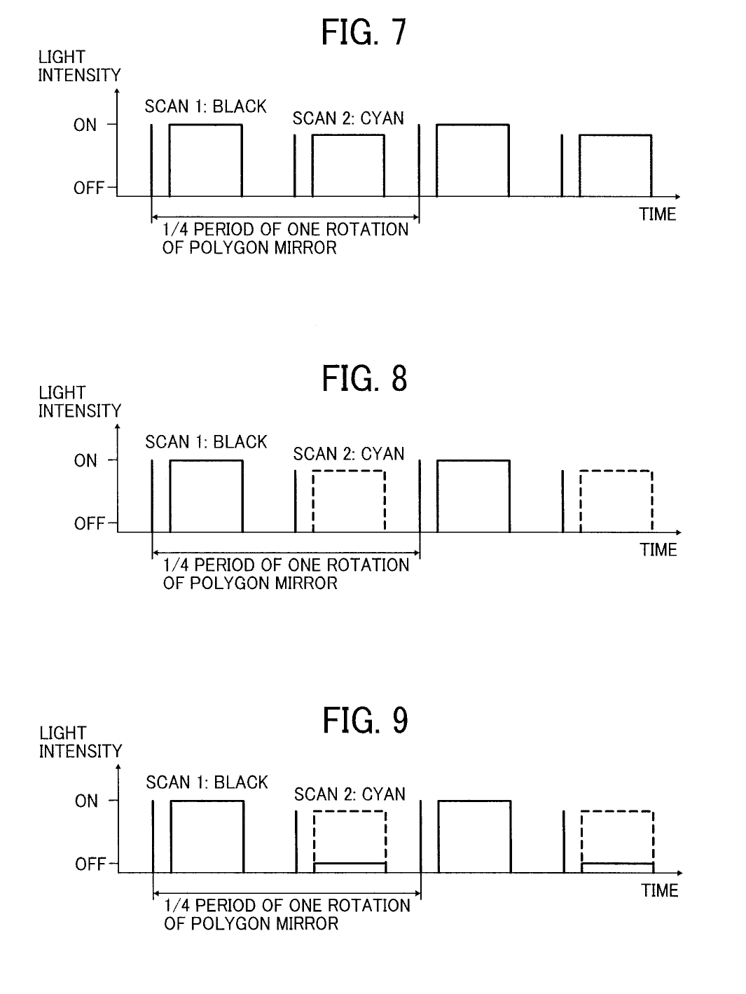

A description is given of a writing operation of electrostatic latent images on the photoconductors 41K and 41C in a full-color printing mode with reference to FIG. 7. FIG. 7 shows a time chart when forming electrostatic latent images of black and cyan in the full-color printing mode. The vertical axis of FIG. 7 indicates the light intensity, and the horizontal axis of FIG. 7 indicates time. The one quarter (¼) period of the polygon mirror 8 means a quarter (¼) of one cycle (i.e., one rotation) of the polygon mirror 8.

In an effective scan area corresponding to the one quarter (¼) period, laser beams are set to ON, and the laser beams deflected at one deflection/reflection face of each one of the upper polygon mirror 8a and the lower polygon mirror 8b scan the photoconductors 41K and 41C. Further, the scan-start timing of the photoconductors 41K and 41C of FIG. 7 can be determined using the synchronization detection sensor.

In the full-color printing mode, the writing determination unit 201 determines that all of the photoconductors 41Y, 41M, 41C, and 41K are required to be written with electrostatic latent images. FIG. 7 shows a scanning process to the photoconductors 41K and 41C among the photoconductors 41Y, 41M, 41C, and 41K, and the compulsory light-OFF instruction unit 204 is not activated.

Based on the instruction of the LD control unit 203, the LD drive circuit 270 controls the LDs 1a and 1b at the light-ON condition so that the photoconductor 41K can be scanned and formed of an electrostatic latent image of black thereon. Specifically, the LD drive circuit 270 sets the light intensity of the laser beams, emitted from the LDs 1a and 1b and passing through the half-mirror prism 5 straight forwardly, at a level corresponding to image data, and such laser beams can be used to form an electrostatic latent image of black on the photoconductor 41K at a scan timing of the photoconductor 41K.

Based on the instruction of the LD control unit 203, the LD drive circuit 270 controls the LDs 1a and 1b at the light-ON condition so that the photoconductor 41C can be scanned and formed of an electrostatic latent image of cyan thereon. Specifically, the LD drive circuit 270 sets the light intensity of the laser beams, emitted from the LDs 1a and 1b and reflected at the reflection face 5b of the half-mirror prism 5, at a level corresponding to image data, and such laser beams can be used to form an electrostatic latent image of black on the photoconductor 41C at a scan timing of the photoconductor 41C.

Further, the LD drive circuit 270 further controls the light-ON timing of other LDs, different from the LDs 1a and 1b so that an electrostatic latent image of magenta and an electrostatic latent image of yellow are respectively written on the photoconductors 44M and 44Y.

The above described control unit 200 includes the writing determination unit 201, the motor control unit 202, and the LD control unit 203. In a case that one or more photoconductors are not required to be written with an electrostatic latent image, based on the instruction of the compulsory light-OFF instruction unit 204, the control unit 200 conducts the light-OFF control using the compulsory light-OFF circuit 271.

A description is given of the light-OFF control with reference to FIG. 8 and the functional block diagrams of FIG. 6. FIG. 8 shows a time chart of scanning operation when one or more photoconductors are not required to be written with an electrostatic latent image. FIG. 8 shows a time chart when forming an electrostatic latent image of black in the black-and-white monochrome image printing mode.

When the writing determination unit 201 receives an instruction of the black-and-white monochrome image printing mode from a printer driver of a personal computer operated by a user via the communication I/F 230, the writing determination unit 201 recognizes image data received with such instruction as a black-and-white monochrome image data, and determines that an electrostatic latent image is not required to be written on the photoconductors 41Y, 41M, and 41C (activation-not-required photoconductor), and determines that an electrostatic latent image is required to be written on the photoconductor 41K (activation-required photoconductor).

Then, the motor control unit 202 instructs the motor drive circuit 260 not to drive the photoconductors 41Y, 41M, and 41C which are not required to be written with the electrostatic latent images (activation-not-required photoconductor), and instructs the motor drive circuit 260 to drive the photoconductor 41K which is required to be written with the electrostatic latent image (activation-required photoconductor). Based on such instruction, the motor drive circuit 260 drives the photoconductor drive motor 220K to rotate the photoconductor 41K.

Further, based on the instruction of the LD control unit 203, as shown in FIG. 8, the LD drive circuit 270 controls the LDs 1a and 1b at the light-ON condition so that the photoconductor 41K can be scanned and formed of an electrostatic latent image of black thereon. Specifically, the LD drive circuit 270 sets the light intensity of the laser beams, emitted from the LDs 1a and 1b and passing through the half-mirror prism 5 straight forwardly, at a level corresponding to image data, and such laser beams can be used to form an electrostatic latent image of black on the photoconductor 41K at a scan timing of the photoconductor 41K (activation-required photoconductor).

Further, based on the instruction from the compulsory light-OFF instruction unit 204, the compulsory light-OFF circuit 271 of the LD drive circuit 270 determines a scan timing to scan the photoconductor 41C (activation-not-required photoconductor) by using the synchronization detection sensor, and the compulsory light-OFF circuit 271 sets the LDs 1a and 1b at the compulsory light-OFF condition. During the scan timing of the photoconductor 41C (activation-not-required photoconductor), the compulsory light-OFF circuit 271 of the LD drive circuit 270 compulsory controls the LDs 1a and 1b at the light-OFF condition (if the LDs 1a and 1b are not set at the light-OFF condition, the photoconductor 41C is scanned by the laser beams, emitted from the LDs 1a and 1b and reflected at the reflection face 5b of the half-mirror prism 5). With such a configuration, as shown in FIG. 8, an optical scanning is not conducted for the photoconductor 41C (activation-not-required photoconductor), which is different from the full-color printing mode shown in FIG. 7.

Further, the compulsory light-OFF circuit 271 also controls other LDs, different from the LDs 1a and 1b, at the compulsory light-OFF condition so that the photoconductors 41Y and 41M (activation-not-required photoconductors) are not scanned.

As such, when the black-and-white monochrome image printing mode is set, a photoconductor required to be written with an electrostatic latent image (activation-not-required photoconductor), and a photoconductor not required to be written with an electrostatic latent image (activation-not-required photoconductor) are both included. Based on an instruction of the compulsory light-OFF instruction unit 204, the LD drive circuit 270 controls the LDs 1a and 1b at the compulsory light-OFF condition so that the photoconductor 41C is not be scanned by the laser beams.

A description is given of a comparison example for the black-and-white monochrome image printing mode with reference to FIG. 9, in which a given bias current is applied to the LDs 1a and 1b. FIG. 9 shows a time chart when forming an electrostatic latent image of black in the black-and-white monochrome image printing mode. As shown in FIG. 9, in the comparison example, the LDs 1a and 1b are set to the light-ON condition for a scan timing of the photoconductor 41K (activation-required photoconductor), and the LDs la and 1b are applied with the given bias current for a scan timing of the photoconductor 41C (activation-not-required photoconductor) so that the LDs 1a and 1b emit light with an offset light intensity. In such a case, if the offset light intensity scans the stopped photoconductor 41C, the offset light intensity scans the photoconductor 41C locally, by which only a part photoconductive layer of the photoconductor 41C receives an optical stress. To prevent such local optical stress, the photoconductor 41C is rotated.

In contrast, in an example embodiment shown in FIG. 8, based on an instruction of the compulsory light-OFF instruction unit 204, the compulsory light-OFF circuit 271 controls the LDs 1a and 1b at the light-OFF condition at a scan timing of the photoconductor 41C by the laser beams for the photoconductor 41C not required to be written with an electrostatic latent image. With such a configuration, unnecessary exposure to a photoconductor not required to be written with an image (i.e., activation-not-required photoconductor) can be prevented. Therefore, compared to the above described comparison example of FIG. 9 that conducts unnecessary exposure by the offset light intensity, in an example embodiment, the optical stress of a photoconductive layer of photoconductor not required to be written with an image can be mitigated.

Such effect can be obtained for the black-and-white monochrome image printing mode and the non-full-color printing mode, wherein the non-full-color printing mode includes a photoconductor required to be written with an image (activation-required photoconductor), and a photoconductor not required to be written with an image (activation-not-required photoconductor), and the LDs 1a and 1b are controlled at the light-OFF condition during the scan timing of the activation-not-required photoconductor.

When a plurality of photoconductors is disposed in an image forming apparatus, during the black-and-white monochrome image printing mode and the non-full-color printing mode, one or more photoconductor are required to be written with an image (activation-required photoconductor), but other one or more photoconductors are not required to be written with an image (activation-not-required photoconductor). In such a case, based on an instruction of the compulsory light-OFF instruction unit 204, the compulsory light-OFF circuit 271 controls the LDs 1a and 1b at the light-OFF condition at a scan timing of the photoconductor not required to be written with the image (activation-not-required photoconductor), by which the above described effect can be obtained.

Further, based on an instruction of the motor control unit 202, the motor drive circuit 260 drives a photoconductor drive motor corresponding to a photoconductor required to be written with an image (activation-required photoconductor), and do not drive a photoconductor drive motor corresponding to a photoconductor not required to be written with an image (activation-not-required photoconductor).

With such a configuration, unnecessary rotation of a photoconductor not required to be written with an image can be omitted, by which mechanical stress of photoconductor can be reduced or mitigated, and aging or degradation of photoconductor may not be unnecessary accelerated, by which the lifetime of photoconductor can be extended. Further, in addition to the no rotation of photoconductor, not required to be written with an image, for example, other controls for electrophotography such as high voltage charge bias control for a charger can be stopped, by which an image forming operation can be conducted by reducing energy consumption.

A description is given of processing in the image forming apparatus 100 with reference to FIG. 1 when an user instructs the black-and-white monochrome image printing mode, in which the control unit 200 instructs various functions to develop an electrostatic latent image formed on the photoconductors 41Y, 41M, 41C, and 41K as a toner image, and the toner image is transferred on the recording sheet P, and the recording sheet P is ejected. Upon receiving an instruction of the black-and-white monochrome image printing mode via a printer driver of personal computer operated by a user, the control unit 200 rotates a sheet feed motor to feed the recording sheet P from the sheet-feed tray 20 in a direction shown by an arrow B in FIG. 1. The recording sheet P is stopped at the registration rollers 23 for the skew correction, and the recording sheet P is maintained at the registration rollers 23.

Further, upon receiving the instruction of the black-and-white monochrome image printing mode, based on the determination result of the writing determination unit 201, the motor control unit 202 instructs a driving of the photoconductor 41K to rotate only the photoconductor 41K (activation-required photoconductor), and the LDs 1a and 1b are controlled at the light-ON condition to write an electrostatic latent image of black on the photoconductor 41K, whereas the compulsory light-OFF instruction unit 204 instructs the compulsory light-OFF circuit 271 to control the LDs 1a and 1b at the light-OFF condition at a scan timing of the photoconductor 41C (activation-not-required photoconductor).

The electrostatic latent image of black formed on the photoconductor 41K is developed by the development unit 41K as a toner image. At a timing that the developed black toner image comes to the transfer nip of the transfer unit 44K, the control unit 200 drives the registration motor and the drive motor to rotate the registration rollers 23 and the transport belt 32 to feed the recording sheet P to the transfer nip of the transfer unit 44K. The black toner image is transferred to the recording sheet P at the transfer nip of the transfer unit 44K. The recording sheet P is applied with heat and pressure in the fusing unit 50 to fuse the black toner image on the recording sheet P, and ejected in a direction shown by an arrow C in FIG. 1 to an ejection tray.

Numerous additional modifications and variations are possible in light of the above teachings for the optical scanning apparatus 10 and the control unit 200. For example, in the optical scanning apparatus 10 of FIG. 2, two laser beams coming from the LDs 1a and 1b are split into four laser beams by the half-mirror prism 5. The two laser beams passed through the half-mirror prism 5 straight forwardly are deflected by the upper polygon mirror 8a and guided to the photoconductor 41K for a multi-beam scanning. Other two laser beams reflected at the reflection face 5b of the half-mirror prism 5 are deflected by the lower polygon mirror 8b and guided to the photoconductor 41C for a multi-beam scanning.

Further, the number of LD can be set to one, in which a single beam scanning is conducted. In such a case, for example, only the LD 1a is used, and one laser beam is split into two laser beams, and each laser beam is respectively guided to the photoconductors 41K and 41C for a single beam scanning. In such a case, the process shown in FIG. 6 and FIG. 8 can be conducted using the motor control unit 202, the LD control unit 203, and the compulsory light-OFF instruction unit 204 of the LD control unit 203, in which the motor control unit 202, the LD control unit 203, and the compulsory light-OFF instruction unit 204 can instruct the motor drive circuit 260, the LD drive circuit 270 and the compulsory light-OFF circuit 271 as above described, by which the above described effect can be obtained. Further, because the number of light sources can be reduced, the malfunction probability can be reduced compared to using two light sources, and the machine cost can be reduced.

In the above described example embodiment, the image forming apparatus 100 is a tandem-type image forming apparatus, in which toner images are sequentially transferred to the recording sheet P directly while the recording sheet P is being transported by the transport belt 32. Further, the image forming apparatus 100 can use an intermediate transfer belt, in which a superimposed toner image is formed on the intermediate transfer belt, and then transferred to the recording sheet P. Further, the image forming apparatus 100 may be digital copiers, facsimile machines, printers or the like.

As above described, an optical scanning apparatus can be used to scan a plurality of photoconductors using split laser beams, in which an unnecessary exposure of a photoconductor not required to be written with an image can be prevented.

The present invention can be implemented in any convenient form, for example using dedicated hardware, or a mixture of dedicated hardware and software. The present invention may be implemented as computer software implemented by one or more networked processing apparatuses. The network can comprise any conventional terrestrial or wireless communications network, such as the Internet. The processing apparatuses can compromise any suitably programmed apparatuses such as a general purpose computer, personal digital assistant, mobile telephone (such as a Wireless Application Protocol (WAP) or 3G-compliant phone) and so on. Since the present invention can be implemented as software, each and every aspect of the present invention thus encompasses computer software implementable on a programmable device.

The computer software can be provided to the programmable device using any storage medium for storing processor readable code such as a flexible disk, a compact disk read only memory (CD-ROM), a digital versatile disk read only memory (DVD-ROM), DVD recording only/rewritable (DVD-R/RW), electrically erasable and programmable read only memory (EEPROM), erasable programmable read only memory (EPROM), a memory card or stick such as USB memory, a memory chip, a mini disk (MD), a magneto optical disc (MO), magnetic tape, a hard disk in a server, a solid state memory device or the like, but not limited these.

The hardware platform includes any desired kind of hardware resources including, for example, a central processing unit (CPU), a random access memory (RAM), and a hard disk drive (HDD). The CPU may be implemented by any desired kind of any desired number of processor. The RAM may be implemented by any desired kind of volatile or non-volatile memory. The HDD may be implemented by any desired kind of non-volatile memory capable of storing a large amount of data. The hardware resources may additionally include an input device, an output device, or a network device, depending on the type of the apparatus. Alternatively, the HDD may be provided outside of the apparatus as long as the HDD is accessible. In this example, the CPU, such as a cache memory of the CPU, and the RAM may function as a physical memory or a primary memory of the apparatus, while the HDD may function as a secondary memory of the apparatus.

In the above-described example embodiment, a computer can be used with a computer-readable program, described by object-oriented programming languages such as C++, Java (registered trademark), JavaScript (registered trademark), Perl, Ruby, or legacy programming languages such as machine language, assembler language to control functional units used for the apparatus or system. For example, a particular computer (e.g., personal computer, work station) may control an information processing apparatus or an image processing apparatus such as image forming apparatus using a computer-readable program, which can execute the above-described processes or steps. In the above described embodiments, at least one or more of the units of apparatus can be implemented in hardware or as a combination of hardware/software combination. In example embodiment, processing units, computing units, or controllers can be configured with using various types of processors, circuits, processing devices, processing circuits or the like such as a programmed processor, a circuit, an application specific integrated circuit (ASIC), used singly or in combination. A circuit is a structural assemblage of electronic components including conventional circuit elements, integrated circuits including application specific integrated circuits, standard integrated circuits, application specific standard products, and field programmable gate arrays. Further a circuit includes central processing units, graphics processing units, and microprocessors which are programmed or configured according to software code. A circuit does not include pure software, although a circuit does include the above-described hardware executing software.

Numerous additional modifications and variations are possible in light of the above teachings. It is therefore to be understood that within the scope of the appended claims, the disclosure of the present invention may be practiced otherwise than as specifically described herein. For example, elements and/or features of different examples and illustrative embodiments may be combined each other and/or substituted for each other within the scope of this disclosure and appended claims.

What is claimed is:

1. An optical scanning apparatus comprising:
a light source to emit a laser beam;
an optical element disposed opposite the light source to split the laser beam into a plurality of laser beams, each of the split laser beams guidable to a corresponding scanning target selected from a plurality of scanning targets when forming a latent image thereon by controlling activation of the light source based on image data while shifting a scanning timing for each of the plurality of scanning targets when forming the latent image thereon; and
a control unit, using a processing device, that switches the light source off for a specific scanning target on which an image is not to be written for a given image forming operation based on specific image data so that the specific scanning target is not scanned even when the specific scanning target enters its scanning timing.

2. An image forming apparatus, comprising:
the optical scanning apparatus of claim 1; and
a plurality of scanning targets scannable by the laser beam emitted from the light source of the optical scanning apparatus.

3. The image forming apparatus of claim 2, configured to selectively drive the plurality of scanning targets during scanning,
wherein, when the optical scanning apparatus scans the plurality of scanning targets, a scanning target on which an image is to be written is driven and a scanning target on which an image is not to be written is not driven.
